(19) United States
(12) Patent Application Publication
(10) Pub. No.: US 2026/0027761 A1
(43) Pub. Date: Jan. 29, 2026

(54) INFORMATION PROCESSING SYSTEM, INJECTION MOLDING MACHINE, AND NON-TRANSITORY COMPUTER-READABLE RECORDING MEDIUM

(71) Applicant: SUMITOMO HEAVY INDUSTRIES, LTD., Tokyo (JP)

(72) Inventors: Yuki MATSUI, Chiba-shi (JP); Daigo HOTTA, Chiba-shi (JP); Yukihiro MAEZAWA, Chiba-shi (JP)

(21) Appl. No.: 19/216,848

(22) Filed: May 23, 2025

(30) Foreign Application Priority Data
Jul. 26, 2024 (JP) 2024-121279

(51) Int. Cl. B29C 45/80

(52) U.S. Cl. CPC B29C 45/80; B29C 2945/76702; B29C 2945/76869; B29C 2945/76913; B29C 2945/76949

(57) ABSTRACT

An information processing system includes: a first estimation unit that uses a simulation model of a first movable portion, which is a portion among movable portions of a control target device and whose operation is not affected by a usage mode, to perform estimation related to an operation of the first movable portion based on a command for controlling an operation of the control target device; and a second estimation unit that receives an estimation result of the first estimation unit and that uses a simulation model of a second movable portion, which is a portion among the movable portions of the control target device and whose operation is affected by the usage mode, to perform estimation related to an operation of the second movable portion.

### CROSS-REFERENCE TO RELATED APPLICATIONS

This application claims priority to Japanese Patent Application No. 2024-121279, filed on Jul. 26, 2024, which is incorporated by reference herein in its entirety.

### BACKGROUND

### Technical Field

Certain embodiments of the present invention relate to an information processing system, an injection molding machine, and a non-transitory computer-readable recording medium.

In control of a device, a simulation is performed, and control information is adjusted based on a result of the simulation.

### Description of Related Art

The related art discloses adjusting a proportional-integral-differential (PID) controller to control an injection pressure of an injection molding machine based on an error between an injection pressure detected by a sensor and a pressure setpoint indicated by a control model in an injection molding system.

The related art discloses, for a device that constitutes an injection molding machine, linearizing a mathematical model obtained by modeling an actual device, performing a simulation, and designing a control system for the device.

### SUMMARY

According to an embodiment of the present invention, there is provided an information processing system including: a first estimation unit that uses a simulation model of a first movable portion, which is a portion among movable portions of a control target device and whose operation is not affected by a usage mode, to perform estimation related to an operation of the first movable portion based on a command for controlling an operation of the control target device; and a second estimation unit that receives an estimation result of the first estimation unit and that uses a simulation model of a second movable portion, which is a portion among the movable portions of the control target device and whose operation is affected by the usage mode, to perform estimation related to an operation of the second movable portion.

### BRIEF DESCRIPTION OF THE DRAWINGS

FIG. 1 is a diagram showing a configuration of an injection molding machine to which the present embodiment is applied.

FIG. 2 is a diagram showing a configuration of a control device.

FIG. 3 is a diagram showing a configuration of a data processing device.

FIG. 4 is a diagram showing a configuration of an information processing device.

FIG. 5 is a diagram showing a hardware configuration example of a computer that implements the information processing device.

FIG. 6 is a diagram showing a configuration example of simulation models used for analysis by an analysis unit of a processing unit of the information processing device.

FIG. 7 is a graph for comparing output waveforms of the simulation models.

FIG. 8 is a diagram showing another configuration example of the simulation models used for analysis by the analysis unit of the processing unit of the information processing device.

FIG. 9 is a diagram showing a configuration example of a multiple linear regression model.

FIG. 10 is a diagram showing a method for deriving a machine learning model.

### DETAILED DESCRIPTION

In a case where a simulation related to the control of the device is performed, it may be necessary to use different simulation models depending on a structure, a usage mode, or the like of the device. However, changing the model used in the simulation according to structures and usage conditions of various devices requires effort.

It is desirable to reduce, for a model used in a simulation related to control of a device, effort required to change a simulation model according to a structure, a usage mode, or the like of the device.

An embodiment of the present invention will be described below in detail with reference to the accompanying drawings.

### Device Configuration

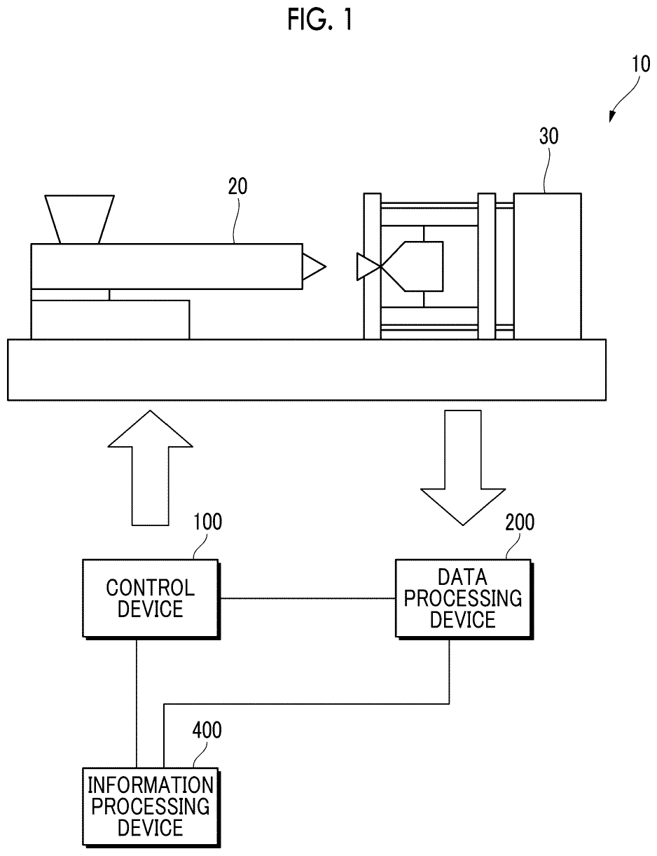

FIG. 1 is a diagram showing a configuration of an injection molding machine to which the present embodiment is applied. An injection molding machine 10 includes an injection unit 20, a mold clamping unit 30, a control device 100, and a data processing device 200. The injection molding machine 10 is an example of a control target device. In addition, an information processing device 400 is connected to the control device 100 and the data processing device 200.

The injection unit 20 includes a cylinder for heating a molding material, a screw that is provided in the cylinder to be capable of rotating and advancing and retreating in an axial direction, a rotary motor that drives the screw in a rotation direction, a motor that drives the screw in the axial direction, and the like. The molding material is, for example, a resin or the like. The injection unit 20 injects the molding material, which has been heated and liquefied in the cylinder, by advancing the screw in a (forward) direction toward the mold clamping unit 30 from the injection unit 20 while rotating the screw, and fills a mold of the mold clamping unit 30 disposed in front of the injection unit 20. The injection unit 20 performs, for example, a plasticizing process, a filling process, a pressure holding process, and the like in a manufacturing process of a molding product. The filling process and the pressure holding process are collectively referred to as an injection process.

The mold clamping unit 30 includes the mold, a clamping mechanism that clamps the mold, a motor that drives the clamping mechanism, and the like. The mold clamping unit 30 closes the mold and receives the molding material injected from the injection unit 20 into the mold. In this case, the mold clamping unit 30 clamps the mold with the clamping mechanism to prevent the mold from opening as the molding material is filled into the mold (mold clamping). The molding product is formed as the molding material filled into the mold solidifies. After that, the mold clamping unit 30 opens the mold, thereby allowing the formed molding product to be removed. The mold clamping unit 30 performs, for example, a mold closing process, a pressure increase process, a mold clamping process, a pressure release process, a mold opening process, and the like in the manufacturing process of the molding product.

The control device 100 is a device that controls operations of the injection unit 20 and the mold clamping unit 30. The data processing device 200 is a device that processes data obtained as the injection unit 20 and the mold clamping unit 30 operate.

The information processing device 400 acquires waveform data obtained by an operation of the injection molding machine 10 from the control device 100 and the data processing device 200 and determines characteristics of the injection molding machine 10 based on the acquired waveform data. The information processing device 400 outputs information for controlling each injection molding machine 10, based on information on the determined characteristics of the injection molding machine 10 and provides the information to the control device 100. Details of the processing by the information processing device 400 and the information output therefrom will be described below.

### Configuration of Control Device 100

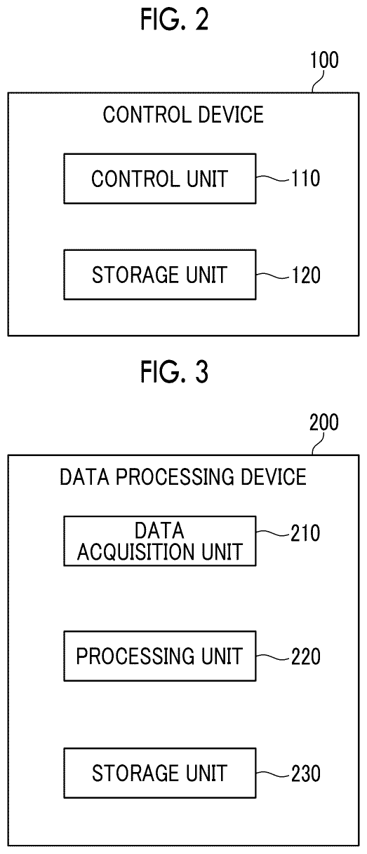

FIG. 2 is a diagram showing a configuration of the control device 100. The control device 100 controls the operations of the injection unit 20 and the mold clamping unit 30. The control device 100 is implemented, for example, by a computer. The control device 100 includes a control unit 110 and a storage unit 120. The control device 100 controls the injection unit 20 and the mold clamping unit 30 to repeatedly perform processes related to the manufacturing of the molding product, thereby repeatedly manufacturing the molding product. The processes related to the manufacturing of the molding product include a plasticizing process, a mold closing process, a pressure increase process, a mold clamping process, a filling process, a pressure holding process, a cooling process, a pressure release process, a mold opening process, an ejection process, and the like. Hereinafter, these processes related to the manufacturing may be collectively referred to as a “manufacturing process”. Additionally, a series of operations for obtaining the molding product, for example, operations from the start of the plasticizing process in the above-described manufacturing process to the start of the next plasticizing process, are referred to as a “shot”, a “molding cycle”, and the like. It should be noted that each of the above-described processes for manufacturing the molding product is merely an example. For example, other processes not included above may also be included as processes executed in a single shot.

The control unit 110 controls the injection unit 20 and the mold clamping unit 30 based on control information. The control information is conditions set by a user and is generated based on information input by the user using, for example, an input unit (not shown). For example, the control information includes molding conditions such as a resin temperature, a mold temperature (a cylinder temperature), an injection pressure holding time, a metering value, a V-P switchover position, a holding pressure, an injection speed (a filling speed), a screw rotation speed, a screw back pressure, and a mold clamping force. A plurality of combinations of these molding conditions are determined depending on the molding product or the mold. This combination data of the molding conditions is hereinafter also referred to as a molding condition dataset. In addition, the control information includes control data such as a voltage, a current, a pressure, a speed, and an acceleration for a drive unit such as a mechanism or a motor. The molding condition dataset is prepared according to the type or the like of the molding product or mold and is stored in the storage unit 120. The molding conditions are an example of an operation condition.

The control unit 110 controls the injection unit 20 and the mold clamping unit 30 using the above-described molding condition dataset and performs the processes related to the manufacturing (shot) of the molding product including the above-described processes and the like. The control unit 110 reads the molding condition dataset corresponding to the molding product to be manufactured from the storage unit 120 at the start of the manufacturing of the molding product or the like. Then, the control unit 110 controls the operations of the injection unit 20 and the mold clamping unit 30 based on the control information including the read molding condition dataset. Specifically, the control unit 110 controls the injection unit 20 and the mold clamping unit 30 such that the data obtained from the injection unit 20 and the mold clamping unit 30 in the manufacturing process matches the set value of the molding condition dataset.

The storage unit 120 stores the control information used by the control unit 110 to control the injection unit 20 and the mold clamping unit 30. The molding condition dataset included in the control information is prepared in association with the molding product or mold to be manufactured. The storage unit 120 stores the molding condition dataset for each molding product or mold to be manufactured. Additionally, although not shown, the storage unit 120 stores a program for the control unit 110 to control the injection unit 20 and the mold clamping unit 30.

### Configuration of Data Processing Device 200

FIG. 3 is a diagram showing a configuration of the data processing device 200. The data processing device 200 acquires and processes data obtained as the injection unit 20 and the mold clamping unit 30 execute operations in the above-described processes related to the manufacturing of the molding product. The data processing device 200 is implemented, for example, by a computer. The data processing device 200 includes a data acquisition unit 210, a processing unit 220, and a storage unit 230.

The data acquisition unit 210 acquires data to be processed from the injection unit 20 and the mold clamping unit 30. Various sensors, detectors, and the like are attached to the injection unit 20 and the mold clamping unit 30. In addition, various measuring devices may be connected to the injection unit 20 or the mold clamping unit 30. Data (hereinafter, referred to as “acquisition data”) acquired by using these sensors, detectors, measuring devices, and the like is information indicating molding results obtained by the injection unit 20 and the mold clamping unit 30 and is used for quality control of the molding product. The data acquisition unit 210 receives the acquisition data transmitted from the sensors, the detectors, the measuring devices, and the like and stores the acquisition data in the storage unit 230.

The processing unit 220 processes the acquisition data stored in the storage unit 230. Specifically, the processing unit 220 performs processing such as extracting a representative value of the acquisition data in each process and generating time-series data obtained by organizing the acquisition data in each process in time-series order. In extracting the representative value, the processing unit 220 performs statistical processing on the acquisition data, such as calculating an average value, specifying a range of possible values, and specifying a maximum value or a minimum value.

The storage unit 230 stores the acquisition data acquired by the data acquisition unit 210. As data formats of the acquisition data stored in the storage unit 230, for example, binary, text, comma-separated values (CSV), INI, YAML Ain′t Markup Language (YAML), JavaScript Object Notation (JSON), and the like may be used. By using these general-purpose data formats as data files, it is possible to perform data exchange of the data files stored in the storage unit 230 with other information processing devices or to edit data files acquired from external devices. Additionally, although not shown, the storage unit 230 stores a program for the processing unit 220 to execute data processing.

### Configuration of Information Processing Device 400

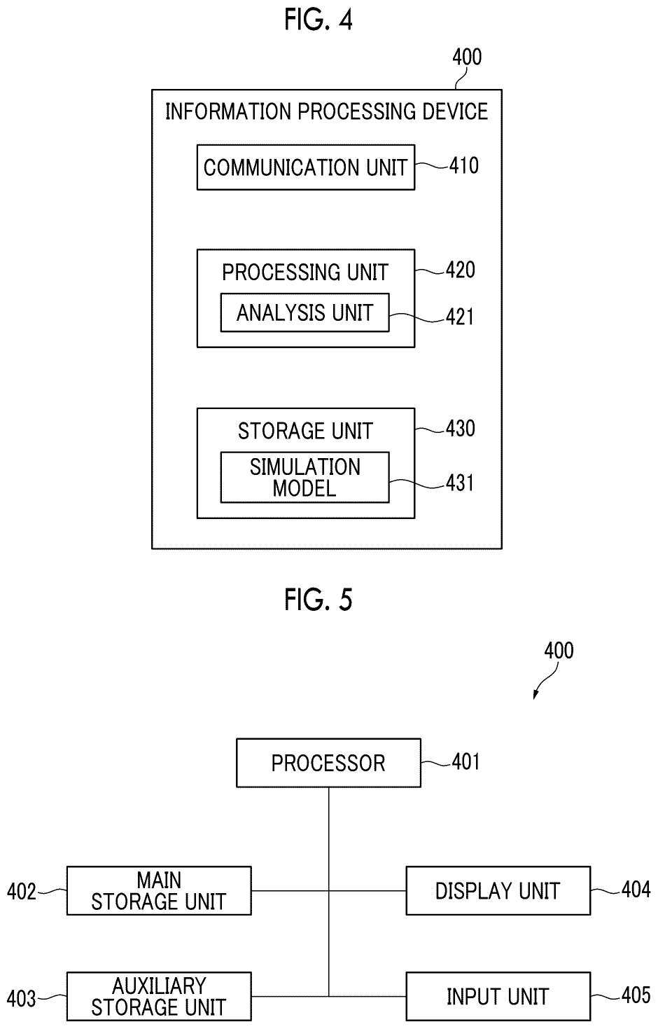

FIG. 4 is a diagram showing a configuration of the information processing device 400. The information processing device 400 executes a simulation of the operation of the injection molding machine 10 using a model of the injection molding machine 10. Then, the information processing device 400 generates and outputs the control information of the injection molding machine 10 based on a result of the simulation. The information processing device 400 is implemented, for example, by a computer. The information processing device 400 includes a communication unit 410, a processing unit 420, and a storage unit 430. The processing unit 420 includes an analysis unit 421 that executes a simulation using a machine learning model or the like to analyze the characteristics of the injection molding machine 10. The storage unit 430 stores a simulation model 431 used for analysis by the analysis unit 421.

The communication unit 410 performs data communication with the control device 100 and the data processing device 200. Specifically, the communication unit 410 transmits the control information of the injection molding machine 10 generated by processing by the processing unit 420 to the control device 100. In addition, the communication unit 410 may also be used in a case where information used for the simulation or analysis is acquired from the control device 100 or the data processing device 200. For example, the control information of the injection unit 20 and the mold clamping unit 30 used for the processing by the processing unit 420 may be acquired from the control device 100. The data to be received may be various types of data obtained as waveform data during the operation of the injection molding machine 10. Specifically, examples thereof include data such as voltages and currents to be supplied to various mechanisms, and speeds, accelerations, and pressures in operations of various mechanisms.

The processing unit 420 performs processing of determining the characteristics of the injection molding machine 10 using the control information of the injection unit 20 and the mold clamping unit 30. The control information of the injection unit 20 and the mold clamping unit 30 may be acquired by being received by the communication unit 410 from the injection unit 20 and the mold clamping unit 30 or may be acquired using control information separately prepared for the simulation.

The analysis unit 421 processes the control information of the injection unit 20 and the mold clamping unit 30 to generate an input variable to be input to the simulation model 431. Then, the analysis unit 421 inputs the generated input variable to the simulation model 431 and outputs a variable (hereinafter, referred to as an “output value”) corresponding to an actual value. Details of the processing by the analysis unit 421 and the simulation model 431 will be described below.

The storage unit 430 stores the control information of the injection unit 20 and the mold clamping unit 30 used for the simulation, the information obtained by the processing by the processing unit 420, the simulation model 431 used by the analysis unit 421 of the processing unit 420, and the like. As data formats of data files stored in the storage unit 430, for example, CSV, Extensible Markup Language (XML), JSON, and the like can be used.

### Hardware Configuration of Information Processing Device 400

FIG. 5 is a diagram showing a hardware configuration example of a computer that implements the information processing device 400. The computer shown in FIG. 5 includes a processor 401 serving as a computing unit, a main storage unit (main memory) 402 serving as a storage unit, and an auxiliary storage unit 403. As the processor 401, for example, a central processing unit (CPU), a graphics processing unit (GPU), an application-specific integrated circuit (ASIC), a field-programmable gate array (FPGA), or other types of computational circuits can be used. The processor 401 reads a program stored in the auxiliary storage unit 403 into the main storage unit 402 and executes the program. As the main storage unit 402, for example, a random-access memory (RAM) is used. As the auxiliary storage unit 403, for example, a magnetic disk device, a solid-state drive (SSD), or the like is used.

Additionally, the computer may include a display unit 404 for displaying an image and an input unit 405 as an input unit for an input operation performed by a user of the computer. As the input unit 405, for example, a keyboard, a mouse, a touch panel, and the like are used. In a case where a touch panel configured integrally with the display unit 404 is used as the input unit 405, the user performs an input operation by touching an operation screen displayed on the display unit 404 with a finger or a pen-type device. The configuration of the computer shown in FIG. 5 is merely an example, and the computer used in the present embodiment is not limited to the configuration example of FIG. 5. For example, a non-volatile memory such as a flash memory or a read-only memory (ROM) may be provided as the storage unit.

In a case where the information processing device 400 is implemented by the computer shown in FIG. 5, the communication unit 410 is implemented, for example, by the processor 401 that reads and executes a program, and a communication interface (not shown). The function of the processing unit 420 is implemented, for example, by the processor 401 reading and executing a program. The storage unit 430 is implemented, for example, by the auxiliary storage unit 403.

### Analysis by Analysis Unit 421

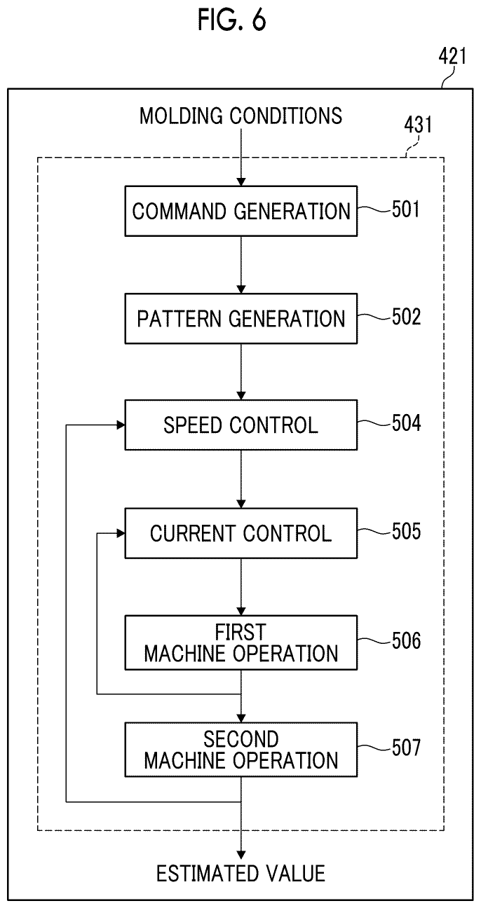

FIG. 6 is a diagram showing a configuration example of simulation models 431 used for the analysis by the analysis unit 421 of the processing unit 420 of the information processing device 400. The analysis unit 421 receives the molding conditions included in the control information and executes various simulations using respective models. The analysis unit 421 executes simulations targeting the operations of the injection unit 20 and the mold clamping unit 30 that constitute the injection molding machine 10. In addition, the simulation may also be executed for the control of the injection molding machine 10 by the control device 100. The simulation by the analysis unit 421 can be configured using, for example, the simulation models 431 such as a command generation 501, a pattern generation 502, a speed control 504, a current control 505, a first machine operation 506, and a second machine operation 507 as shown in FIG. 6.

The command generation 501 and the pattern generation 502 are simulation models that generate commands for operating the injection molding machine 10, based on the molding conditions for controlling the injection molding machine 10. Here, in the actual injection molding machine 10, commands for controlling the operations of the injection unit 20 and the mold clamping unit 30 are generated by the control device 100 based on the molding conditions. Calculation models used in the command generation 501 and the pattern generation 502 are the same as calculation models used to generate the commands in the control device 100. The analysis unit 421 that performs the simulations using the command generation 501 and the pattern generation 502 is an example of a command generation unit. The analysis unit 421 first generates a command for operating the injection molding machine 10 using the simulation model of the command generation 501. In the command generation 501, the molding conditions of injection molding are converted into the command for operating the injection molding machine 10. This command is an instruction for designating a speed, a pressure, or the like in the operation of the injection molding machine 10. The command generated by the command generation 501 corresponds to the setting of the operation of the injection molding machine 10 by the user.

Next, the analysis unit 421 uses the simulation model of the pattern generation 502 to convert the command generated by the command generation 501 into a command that can be followed by the actual device (injection molding machine 10). The actual device has difficulty in operating in accordance with the command corresponding to the molding conditions due to physical constraints of the device. Therefore, in the pattern generation 502, the command generated by the command generation 501 is converted into a command of a content that can be followed by the actual device. Specifically, for example, in a situation where an operation speed changes in the command generated by the command generation 501, the command is converted to operate such that the speed changes with a certain delay due to acceleration motion instead of immediately switching to a different speed at the timing at which the speed changes.

The speed control 504 and the current control 505 are simulation models that generate information indicating control contents of the motor, which is a drive source of the injection molding machine 10. In the speed control 504 and the current control 505, pattern information representing a control pattern of the motor in a case where the motor of the injection molding machine 10 is operated in accordance with the command generated by the pattern generation 502 is output. The pattern information is generated as, for example, waveform data. The format of the waveform data is not particularly limited. For example, the format of the waveform data may be data in which values are listed, such as CSV, or a waveform diagram. The analysis unit 421 that performs the simulations using the speed control 504 and the current control 505 is an example of a pattern information generation unit.

The analysis unit 421 first performs a simulation of the operation speed of the motor using the simulation model of the speed control 504 and generates pattern information (current command) on current changes. The pattern information is generated, for example, as waveform data representing a relationship between the elapsed time and the current. Next, the analysis unit 421 performs a simulation of the current to be supplied to the motor using the simulation model of the current control 505 and generates pattern information (voltage command) on voltage changes. In the current control 505, the voltage to be supplied to the motor is specified in order to implement control corresponding to the operation speed of the motor generated by the speed control 504. For example, the pattern information is output as waveform data representing a relationship between the elapsed time and the voltage to be supplied to the motor.

The first machine operation 506 and the second machine operation 507 are simulation models of the operation of the injection molding machine 10. The first machine operation 506 is a simulation model for the operation of the motor, which is the drive source of the injection molding machine 10. The second machine operation 507 is a simulation model for an operation of a movable portion that operates by receiving a driving force of the motor in the injection molding machine 10. The motor, which is a target of the simulation using the first machine operation 506, is an example of a first movable portion. Additionally, the movable portion, which is a target of the simulation using the second machine operation 507, is an example of a second movable portion.

The first machine operation 506 and the second machine operation 507 are implemented, for example, as machine learning models. As the machine learning model, for example, a multiple linear regression model is used. In the first machine operation 506 and the second machine operation 507, operation information indicating a result of an operation of a machine that constitutes the actual injection molding machine 10 is output. In the example shown in FIG. 6, operation information regarding the operation speed of the injection molding machine 10 is generated. The analysis unit 421 that performs the simulation using the first machine operation 506 is an example of a first estimation unit. In addition, the analysis unit 421 that performs the simulation using the second machine operation 507 is an example of a second estimation unit.

The analysis unit 421 first executes the simulation of the operation of the motor using the simulation model of the first machine operation 506. The analysis unit 421 extracts an input variable from the waveform data output from the current control 505 and inputs the input variable to the first machine operation 506. In the first machine operation 506, the simulation of the operation of the motor is executed to calculate an output variable (estimated value) corresponding to the input variable. The input variable is a variable related to the torque of the motor. Examples of the input variable include a d-axis current, a q-axis current, and a speed. For the output variable, information that can be used to calculate the torque of the motor in the second machine operation 507 is selected. Examples of the output variable include an estimated value of the motor torque itself and an estimated value of the current to be supplied to the motor.

Next, the analysis unit 421 executes a simulation of the operation of the movable portion of the injection molding machine 10 using the simulation model of the second machine operation 507. The analysis unit 421 inputs the estimated value output from the first machine operation 506 as an input variable to the second machine operation 507. In the second machine operation 507, the simulation of the operation of the movable portion of the injection molding machine 10 is executed to calculate an output variable (estimated value) corresponding to the input estimated value. For the output variable, various types of information regarding the operation of the movable portion as the target of the simulation are selected. Examples of the output variable include estimated values of the operation speed, the acceleration, and a position of the movable portion, and an estimated value of the current to be supplied to the injection molding machine 10. Additionally, information (parameters) that can be used to calculate the estimated values, instead of the estimated values such as the operation speed and the current, may be output. The simulation model of the second machine operation 507 includes information such as the weight of the mold, the viscosity of the molding material (resin), and the distinction between a belt drive and a DD drive (drive by a direct drive motor).

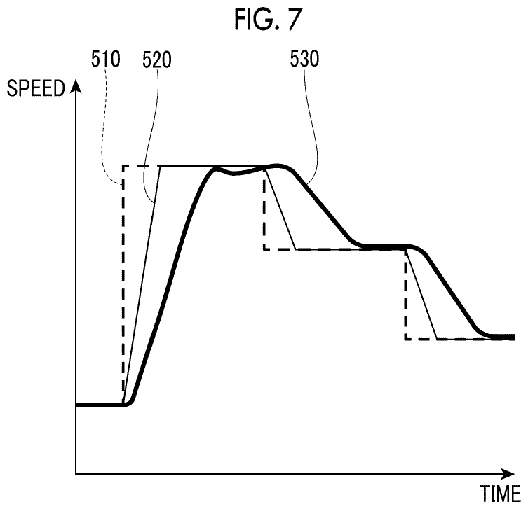

FIG. 7 is a graph for comparing output waveforms of the simulation models. Here, waveform data indicating a relationship between the operation speed of the motor and the time is compared for the outputs of the command generation 501, the pattern generation 502, and the second machine operation 507. In FIG. 7, each waveform data is represented by a waveform diagram representing a relationship between the speed and the time. In FIG. 7, the waveform data, which is the output of the command generation 501, is represented by a waveform diagram 510 indicated by a dashed line. The waveform data, which is the output of the pattern generation 502, is represented by a waveform diagram 520 indicated by a thin solid line. The waveform data, which is the output of the second machine operation 507, is represented by a waveform diagram 530 indicated by a thick solid line.

As mentioned above, the waveform data (waveform diagram 510), which is the output of the command generation 501, shows a steep speed transition at a certain point in time. This is an operation based on the molding conditions by the user; however, it is difficult for the actual device to operate the motor as shown in the waveform diagram 510 due to effects of inertia, output control, or the like. The waveform data (waveform diagram 520), which is the output of the pattern generation 502, follows the speed change shown in the waveform diagram 510 with a certain delay due to the acceleration motion at the timing at which the speed of the waveform diagram 510 transitions.

The waveform data (waveform diagram 530), which is the output of the second machine operation 507, further shows a state of the speed change that reflects the inertia or operation characteristics of the motor or the movable portion of the injection molding machine 10. In FIG. 7, regarding the waveform diagram 530, a state is shown in which the speed changes in a curved manner with an even further delay as compared to the waveform diagram 520.

### Adjustment of Simulation Model

As shown in FIG. 6, the output value (the estimated value of the current to be supplied to the motor) of the first machine operation 506 is fed back to the current control 505. The analysis unit 421 compares the output value of the first machine operation 506 for the current with the output value (current command) of the speed control 504 to be input to the current control 505 and calculates an error. Then, the analysis unit 421 adjusts the physical quantities (parameters) included in the simulation model of the first machine operation 506 such that the error between the output value of the current control 505 and the value that is calculated through the multiple linear regression model for the output value of the first machine operation 506 is minimized.

In addition, the output value (the estimated value of the operation of the movable portion of the injection molding machine 10) of the second machine operation 507 is fed back to the speed control 504. The analysis unit 421 compares the output value of the second machine operation 507 for the speed with the output value (speed command) of the pattern generation 502 to be input to the speed control 504 and calculates an error. Then, the analysis unit 421 adjusts the physical quantities (parameters) included in the simulation model of the second machine operation 507 such that the error between the output value of the first machine operation 506 and the value that is calculated through the multiple linear regression model for the output value of the second machine operation 507 is minimized.

### Configuration of Simulation Model Group

The configuration of a simulation model group will be further described. As the simulation models used for the analysis by the analysis unit 421, in the example shown in FIG. 6, the command generation 501, the pattern generation 502, the speed control 504, the current control 505, the first machine operation 506, and the second machine operation 507 are shown. That is, in the above-described configuration example, as the simulation models of the operation of the injection molding machine 10, the first machine operation 506, which is the simulation model of the operation of the motor, and the second machine operation 507, which is the simulation model of the operation of the movable portion of the injection molding machine 10, are provided.

Here, the motor that is the target of the simulation of the first machine operation 506 has operation characteristics that remain unchanged during the use of the injection molding machine 10. In other words, the motor can be said to be a movable portion that is not affected by the usage mode among the movable portions of the injection molding machine 10. Therefore, the operation characteristics of the motor can be specified at the time of shipment of the injection molding machine 10. On the other hand, various movable portions other than the motor in the injection molding machine 10 may have operation characteristics that significantly change due to the effects of the usage mode of the injection molding machine 10. Specific examples thereof include a case where the inertia differs due to changes in the mold or a case where the pressure applied differs due to variations in molding conditions or molding materials.

Therefore, in the present embodiment, the first machine operation 506, which is the simulation model of the operation of the motor, and the second machine operation 507, which is the simulation model of the operation of the movable portion of the injection molding machine 10, are configured separately. By making the first machine operation 506 independent, the simulation model of the first machine operation 506 can be derived at the time of shipment of the injection molding machine 10. Moreover, for injection molding machines 10 that use the same motor, the first machine operation 506 based on the common simulation model can be applied.

Meanwhile, by separating the simulation model for the operation of the motor from the second machine operation 507, the simulation model need only be derived solely for the operation of the movable portion, excluding the motor, according to the mode for use of the injection molding machine 10. Additionally, in order to derive the simulation model, it is necessary to actually operate the injection molding machine 10 to acquire the control information or the information on the operation characteristics, and to adjust the simulation model based on the acquired information. However, in general, the injection molding machine 10 is not provided with a sensor for obtaining the information on the operation characteristics such as the torque of the motor. Therefore, in a case where the simulation model corresponding to the mode for use is derived after the shipment of the injection molding machine 10, it is easier to perform a derivation process when the simulation model of the motor portion is separated.

In the simulation model used for the analysis by the analysis unit 421, the first machine operation 506 is not essential. In a case where the simulation by the first machine operation 506 is omitted, the current control 505 that outputs the voltage command to be input to the first machine operation 506 is also omitted. That is, the input variable extracted from the waveform data output from the speed control 504 may be directly input to the second machine operation 507. Even with such a configuration, the operation speed of the movable portion of the injection molding machine 10 can be estimated based on the output of the second machine operation 507. However, in this case, since the estimation of the operation characteristics of the motor by the first machine operation 506 is not reflected, the accuracy of the output estimated value decreases as compared to that in a case where the first machine operation 506 is provided.

In addition, the pattern generation 502 and the current control 505 are not essential in the same manner. In a case where the pattern generation 502 is not provided, the input variable extracted from the output of the command generation 501 is input to a simulation model downstream of the pattern generation 502. In a case where the current control 505 is not provided, the input variable extracted from the output of a simulation model upstream of the current control 505 is input to a simulation model downstream of the first machine operation 506. In any case, since the estimation by the omitted simulation models is not reflected, the accuracy of the estimated value output from the second machine operation 507 decreases as compared to that in a case where these simulation models are provided.

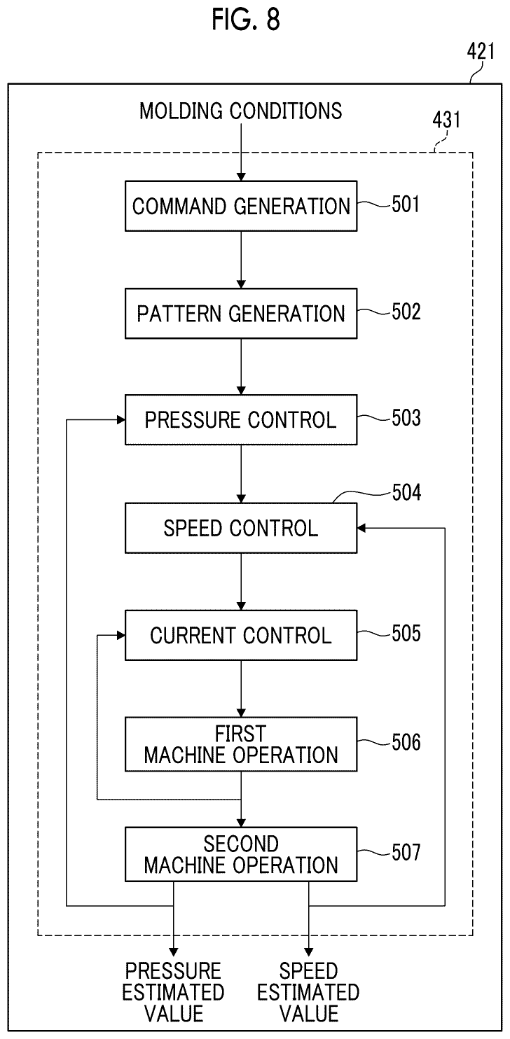

In the configuration example shown in FIG. 6, the command for operating the injection molding machine 10 is generated (simulated) using the command generation 501 and the pattern generation 502. Meanwhile, commands for actually controlling the operations of the injection unit 20 and the mold clamping unit 30 may be generated using the control device 100 of the injection molding machine 10. The generated commands are transmitted from the control device 100 to the information processing device 400. Then, the analysis unit 421 of the information processing device 400 generates the pattern information using the speed control 504 and the current control 505, based on the acquired commands. The same applies to a modification example shown in FIG. 8, which will be described below. Application to Control Device 100

After each simulation model is adjusted as described above, the user executes the simulations using the simulation models in the information processing device 400. Then, the user generates control information for implementing a desired operation according to the characteristics of the injection molding machine 10, based on the estimated values obtained by the simulations in the information processing device 400, and transmits the control information to the control device 100. The control device 100 controls the operations of the injection unit 20 and the mold clamping unit 30 based on the control information acquired from the information processing device 400 and performs the processes related to the manufacturing of the molding product.

### Modification Example

FIG. 8 is a diagram showing another configuration example of the simulation models used for the analysis by the analysis unit 421 of the processing unit 420 of the information processing device 400. The simulation models in the example shown in FIG. 8 may be configured using simulation models such as the command generation 501, the pattern generation 502, a pressure control 503, the speed control 504, the current control 505, the first machine operation 506, and the second machine operation 507. In the configuration example shown in FIG. 8, the pressure control 503 is added as compared to the configuration example shown in FIG. 6. The pressure control 503 is provided between the pattern generation 502 and the speed control 504. That is, the output of the pattern generation 502 is input to the pressure control 503, and the output of the pressure control 503 is input to the speed control 504. The simulation models of the command generation 501, the pattern generation 502, the speed control 504, the current control 505, the first machine operation 506, and the second machine operation 507 are the same as the simulation models shown in FIG. 6, respectively.

In the configuration shown in FIG. 8, the pressure control 503 is a simulation model that generates information indicating a control content of the movable portion of the injection molding machine 10. In the pressure control 503, pattern information representing the control content of the pressure in a case where the injection molding machine 10 is operated in accordance with the command generated by the pattern generation 502 is output. The pattern information is generated as, for example, waveform data. The format of the waveform data is not particularly limited and may be data in which values are listed, such as CSV, or a waveform diagram. The analysis unit 421 that performs the simulation using the pressure control 503 is an example of a pattern information generation unit.

In the configuration shown in FIG. 8, the analysis unit 421 uses the simulation model of the pressure control 503 to generate the pattern information of the movable portion, which is the target of the simulation in the injection molding machine 10. The pattern information is generated, for example, as waveform data representing a relationship between the elapsed time and the pressure change. After that, the analysis unit 421 generates the pattern information of the speed using the speed control 504.

As shown in FIG. 8, in a case where the pressure control 503 is provided, the output value of the second machine operation 507 is fed back to the pressure control 503. The analysis unit 421 compares the output value of the second machine operation 507 for the pressure with the output value of the pressure control 503 and calculates an error. Then, the analysis unit 421 adjusts the simulation model of the speed control 504 such that the error between the output value of the pressure control 503 and the output value of the second machine operation 507 is minimized.

As described above, in the example described with reference to FIG. 6, the operation speed and the current of the movable portion of the injection molding machine 10 are estimated, and in the modification example described with reference to FIG. 8, the simulation for further estimating the pressure has been described. Additionally, by selecting the waveform data that can be acquired from the injection molding machine 10 via the output of the sensor and the like, it is possible to obtain estimated values of a force acting on the movable portion such as a mold clamping force, an acceleration of the movable portion, a position of the movable portion (such as displacement or rotation angle), a position of a platen, and the like.

### Specific Example of Method for Deriving Machine Learning Model

Next, a specific example of a method for deriving a machine learning model used as the simulation models of the first machine operation 506 and the second machine operation 507 will be described. Here, as an example, a derivation example of the simulation model of the operation of the motor used in the first machine operation 506 will be described. First, a multiple linear regression model, which is an example of the machine learning model, will be described, and then the method for deriving a machine learning model will be described.

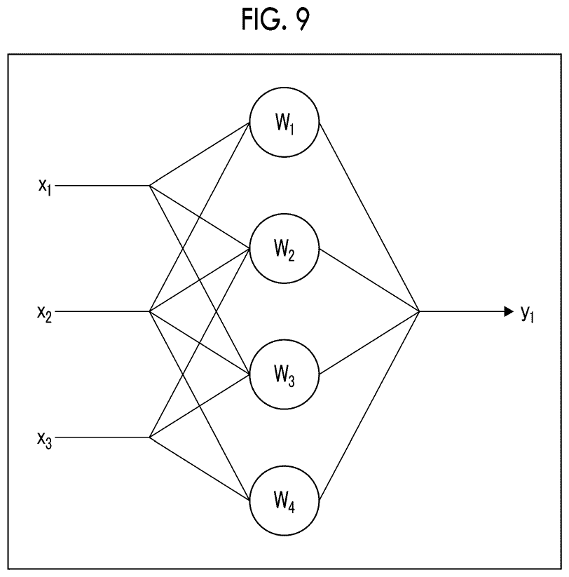

FIG. 9 is a diagram showing a configuration example of the multiple linear regression model. The shown multiple linear regression model receives a plurality of inputs, performs analysis while taking into consideration a correlation relationship among the inputs using a plurality of nodes representing a plurality of units of processing, and obtains a single output. In the model shown in FIGS. 9, x₁ to x₃ are input variables, and y₁ is an output. Values w₁ to w₄ written in the nodes of an intermediate layer represent weight values set for the respective nodes. That is, in the model shown in FIG. 9, when the input variables x₁ to x₃ are given, the output y₁ is obtained through processing using the weight values w₁ to w₄ in the respective nodes. Then, by changing the weight values w₁ to w₄ of the respective nodes, a different output y₁ is obtained for the same input variables x₁ to x₃. The number of input variables and nodes shown in FIG. 9 is merely an example and is not limited to the shown number.

In a case where the multiple linear regression model shown in FIG. 9 is applied to the relationship between the current and the voltage, for example, the actual currents are input to the input variables x₁ to x₃, and, for example, the voltage command is obtained as the output y₁. Then, for example, physical constants are set for the weight values w₁ to w₄ of respective nodes. The types of physical constants set for the weight values w₁ to w₄ are selected according to the physical quantities to be analyzed. For example, in a case where the actual current of the motor is used as an input, and the voltage command is used as an output, physical constants such as a resistance value (R), a d-axis inductance (Ld), a q-axis inductance (Lq), a back electromotive force constant (Ke), a torque constant (Kt), viscous friction (Dm), and inertia (J) of the motor can be assigned to the nodes and the weight values can be set.

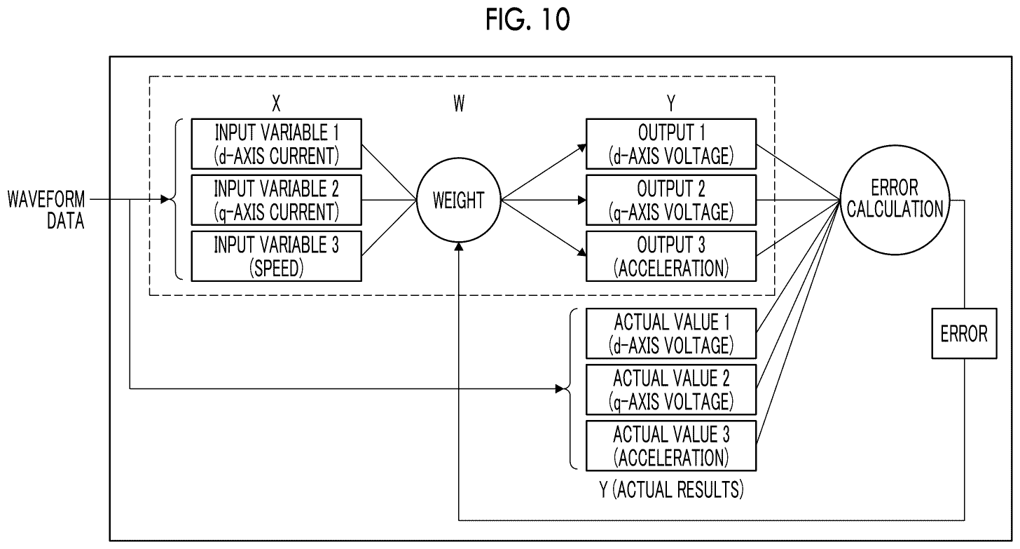

FIG. 10 is a diagram showing a method for deriving a machine learning model. The simulation model of the first machine operation 506 is derived by analyzing the waveform data acquired from the injection molding machine 10, which is the control target device, through supervised learning using, for example, the multiple linear regression model as described with reference to FIG. 9. Here, as an example, the simulation model is a model that obtains the voltage and the acceleration from the actual current and the actual speed of the motor. In FIG. 10, the intermediate layer in the model is described as a single node collectively.

First, the d-axis current, the q-axis current, and the speed are extracted as the input variables X from the waveform data acquired from the injection molding machine 10 and are input to the simulation model. In addition, the actual values (Y (actual results)) of the d-axis voltage, the q-axis voltage, and the acceleration are extracted from the waveform data. These actual values correspond to output contents calculated by the simulation model based on the input variables, which are the d-axis current, the q-axis current, and the speed.

Meanwhile, the simulation model obtains the d-axis voltage, the q-axis voltage, and the acceleration as the outputs (Y) based on the input d-axis current, the q-axis current, and the speed, respectively. Here, the d-axis voltage, the q-axis voltage, and the acceleration are determined based on the d-axis current, the q-axis current, and the speed, respectively.

Next, the actual values (Y (actual results)) of the d-axis voltage, the q-axis voltage, and the acceleration extracted from the waveform data are compared with the outputs (Y) of the d-axis voltage, the q-axis voltage, and the acceleration obtained using the simulation model, and errors are calculated. Then, the weight value W of each node in the intermediate layer is corrected such that the error is minimized, in other words, such that the outputs (Y) of the d-axis voltage, the q-axis voltage, and the acceleration match the actual values (Y (actual results)) of the d-axis voltage, the q-axis voltage, and the acceleration. In a case where the weight value W that minimizes the errors between the outputs (Y) of the d-axis voltage, the q-axis voltage, and the acceleration and the actual values (Y (actual results)) of the d-axis voltage, the q-axis voltage, and the acceleration is obtained, the weight value W represents the characteristics of the motor of the injection molding machine 10, which is an acquisition source of the input waveform data.

In the above-described example, the derivation example of the simulation model of the operation of the motor used in the first machine operation 506 has been described, but the derivation of the simulation model of the operation of the movable portion used in the second machine operation 507 is also performed in the same manner. In deriving the simulation model of the second machine operation 507, the input variable and the output variable are set according to the operation of the movable portion, which is the target of the simulation. It has been described that the movable portion, which is the target of the simulation of the second machine operation 507, may require a change in the simulation model when the usage mode of the injection molding machine 10 is changed. Therefore, in a case where the usage mode of the injection molding machine 10 is changed, the injection molding machine 10 is operated to acquire the physical quantities relating to the operation of the movable portion in the new usage mode, the input variable and the output variable are set to execute the simulation, and the simulation model is adjusted.

Although the embodiments of the present invention have been described above, the technical scope of the present invention is not limited to the above-described embodiments. For example, in the above-described embodiments, the waveform data is analyzed and the control information is generated by the information processing device 400 connected to the injection molding machine 10. However, the control device 100 or the data processing device 200 of the injection molding machine 10 may be configured to analyze the waveform data and generate the control information. In other words, the functions of the information processing device 400 may be implemented by the injection molding machine 10. In addition, various changes and alternative configurations that do not depart from the scope of the technical concept of the present invention are included in the present invention.

It should be understood that the invention is not limited to the above-described embodiment, but may be modified into various forms on the basis of the spirit of the invention. Additionally, the modifications are included in the scope of the invention.

What is claimed is:

1. An information processing system comprising:
a first estimation unit that uses a simulation model of a first movable portion, which is a portion among movable portions of a control target device and whose operation is not affected by a usage mode, to perform estimation related to an operation of the first movable portion based on a command for controlling an operation of the control target device; and
a second estimation unit that receives an estimation result of the first estimation unit and that uses a simulation model of a second movable portion, which is a portion among the movable portions of the control target device and whose operation is affected by the usage mode, to perform estimation related to an operation of the second movable portion.

2. The information processing system according to claim 1,
wherein the first estimation unit performs estimation related to an operation of a motor, which is a drive source of the control target device, as the first movable portion.

3. The information processing system according to claim 1, further comprising:
a command generation unit that receives information related to an operation condition of the control target device and that generates the command based on the received information,
wherein the first estimation unit receives the command generated by the command generation unit and performs estimation related to the operation of the first movable portion.

4. The information processing system according to claim 1, further comprising:
a pattern information generation unit that generates pattern information related to the operation of the control target device based on the command,
wherein the first estimation unit receives the pattern information generated by the pattern information generation unit to perform estimation related to the operation of the first movable portion, and
the pattern information generation unit corrects a computational model for generating the pattern information, based on an estimation result of at least one of the first estimation unit and the second estimation unit.

5. The information processing system according to claim 1, further comprising:
a communication unit;
a processing unit; and
a storage unit,
wherein the first estimation unit and the second estimation unit constitute an analysis unit of the processing unit.

6. The information processing system according to claim 5,
wherein the communication unit transmits control information of the control target device generated by processing by the processing unit to a control device.

7. The information processing system according to claim 5,
wherein the storage unit stores control information of the control target device used for a simulation, information obtained by processing by the processing unit, and a simulation model used by the analysis unit of the processing unit.

8. The information processing system according to claim 5,
wherein a function of the processing unit is implemented by a processor reading and executing a program stored in the storage unit.

9. The information processing system according to claim 1,
wherein the control target device is an injection molding machine.

10. An injection molding machine comprising:
an injection unit and a mold clamping unit that execute processes in injection molding; and
a control device that controls operations of the injection unit and the mold clamping unit,
wherein the control device includes
the information processing system according to claim 1, and
a control unit that controls the operations of the injection unit and the mold clamping unit based on control information reflecting an estimation result by the information processing system.

11. A non-transitory computer-readable recording medium storing a program, the program causing a computer to:
use a simulation model of a first movable portion, which is a portion among movable portions of a control target device and whose operation is not affected by a usage mode, to perform estimation related to an operation of the first movable portion based on a command for controlling an operation of the control target device; and
receive an estimation result of the estimation and use a simulation model of a second movable portion, which is a portion among the movable portions of the control target device and whose operation is affected by the usage mode, to perform estimation related to an operation of the second movable portion.
